(19) United States
(12) Patent Application Publication
(10) Pub. No.: US 2008/0065681 A1
(43) Pub. Date: Mar. 13, 2008

(54) Method of Annotating Timeline Files

(75) Inventors: Wilhelmus Francisus Johannes Fontijn, Eindhoven (NL); Declan Patrick Kelly, Shanghai (CN); Bei Wang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,374

(22) PCT Filed: Oct. 14, 2005
(86) PCT No.: PCT/IB05/53382

§ 371 Date: Apr. 17, 2007

(30) Foreign Application Priority Data
Oct. 21, 2004 (EP) 04105231.7

(51) Int. Cl. G06F 17/30

(52) U.S. Cl. 707/102; 707/E17.048

(57) ABSTRACT

The invention describes a method of annotating a timeline file (T) which method comprises identifying distinct key resources (K₁, K₂, K₃, . . . , Kₘ) in the timeline file (T), and describing a number of annotations for one or more key resources (K₁, K₂, K₃, . . . , Kₘ) in an annotation file (A) such that an annotation for a key resource (K₁, K₂, K₃, . . . , Kₘ) is tied to the key resource (K₁, K₂, K₃, . . . , Kₘ) corresponding to that annotation.

The invention relates to a method for annotating timeline files.

The invention further relates to a method for presenting such a timeline file.

The invention further relates to an arrangement for annotating a timeline file.

The invention further relates to an arrangement for presenting a timeline file comprising a number of key resources according to annotations described in a corresponding annotation file.

The invention further relates to a computer program product directly loadable into the memory of a programmable device, comprising software code portions for performing the steps of a method according to the first paragraph and the second paragraph, respectively, when said product is run on the device.

A timeline file is a special type of file, stored in a computer system, used to specify a set of audiovisual elements, such as video, audio, text etc., the location of the elements in the system, and sequence of play for these elements. In its simplest form, a timeline file might comprise a single audiovisual element such as movie stored in, for example, MPEG format. Equally, it might define a more complex playing sequence for a number of audio-visual elements, such as a sequence of images, an accompanying soundtrack, and a voice-over. Other examples of more complex timeline files include the enhanced DVD (Digital Versatile Disc) and BD (Blu-ray Disc) file formats. Such a timeline file is usually encoded in an appropriate language, such as, for example, an extensible markup language (XML). A markup language is used to identify structures in a document, and an extensible markup language is a meta-language whose semantics will either be defined by the application that processes the XML document, or by a stylesheet, so that the XML can be tailored to suit the requirements of the application. One example of a markup language suitable for encoding timeline files is SMIL (“Synchronised Multimedia Integration Language”), and the application which processes the timeline files would be a player.

An annotation to a file or an element of a file comprises a critical or explanatory note, comment, or modification for that file or file element. For example, an annotation to a timeline file might comprise the addition or removal of an audio-visual element, a text message commenting on an element of the base file, a drawing to draw attention to a specific part of a video, a spoken comment on an image, karaoke singing, etc. Any annotations to a timeline file are encoded in a separate annotation file, which typically references the timeline file by name, so that a player of the annotation file can access the timeline file on the system, as well as any elements referenced by the timeline file itself. Evidently, performance of a player and understanding of the annotation files by a user will be optimal if the annotation file is also encoded in a similar manner to the base file.

An obvious way to express the association between an annotation file and an annotated timeline file is to include the filename of the original timeline file in the header of the annotation file. However, renaming the original timeline file would break this link. Also, there may exist several versions of the original timeline file, similar enough to allow a single annotation file to describe annotations to them, but at the same time sufficiently different to warrant different instances of the original file. Furthermore, changes can be made to the original base file, with the result that content, play duration etc. might be altered, or that elements might be added or removed to the playlist. If these modifications are not reflected in the annotation file, they will also not be evident to the player, with the result that processing of the timeline file together with the annotation file has undesirable results.

Therefore, an object of the present invention is to provide a method of annotating a timeline file in such a way that the above-mentioned problems are circumvented.

To this end, the present invention provides a method of annotating a timeline file, which method comprises identifying distinct key resources in the timeline file and describing a number of annotations for one or more key resources in an annotation file such that an annotation for a key resource is tied to the key resource corresponding to that annotation.

A timeline file, sometimes also referred to as a base file or timeline base file, is, as already explained above, a file containing a structured timeline or playlist specifying playing information for any audio-visual resources or elements referenced from or contained in the timeline file. Any number of elements or resources can be included, directly or by reference, in the timeline file, and relevant information such as individual playing times, relative position on a screen, loudness etc., can be specified in the timeline or playlist. Resources of the playlist can be scheduled to run one after the other (sequentially) or at the same time (parallel).

A resource can be any kind of media content such as a video stream, an audio stream, an image etc. A resource can be stored as a file on a file system in any suitable format such as MPEG (Moving Pictures Experts Group) format, JPEG (Joint Photographic Experts Group) format, etc. A file system can be a computer hard-disk, a CD (compact disc), DVD, etc. A “key resource” of such a timeline file is any resource which is considered very relevant to the timeline. Any such very relevant resource can be termed a “carrier” of the playlist or timeline, and are considered to be “key resources” according to the invention. Depending on the playlist, one or more of the resources or elements might be considered very relevant to the overall playlist, whilst the remaining resources might be less relevant. For example, a movie of a playlist is clearly more relevant than a logo which is only visible for a moment when the movie is being played.

Whether or not a resource of a timeline is to be considered as a key resource can be determined, for instance, by the author of the timeline file, automatically by an editor, or by a user writing an annotation file. Essentially any or even all of the resources of a timeline file can be considered to be key resources, should this be desired. This might be the case for timeline files which comprise only a small number of resources.

Any key resource of the timeline file can be augmented by an annotation in an annotation file. The annotation refers to the key resource, preferably by supplying a unique file name for the key resource, which may require a file path for locating the key resource on a file system, and in such a way that the annotation is tied to the key resource. By unambiguously tying the annotation to the key resource, as will be explained in more detail below, the situation can be avoided in which a key resource is played with an annotation, even though the key resource has been modified after the annotation for that key resource has been created. Therefore, the present invention provides a simple but robust method of ensuring that a key resource is only presented with its annotation if the version of the key resource is that for which the annotation was created.

An annotation can provide additional descriptive information for a key resource, such as an audio commentary to accompany a slide show of a collection of photo images, or a graphic image, such as a hand-drawn sketch, to be overlaid over an image. Equally, an annotation can simply modify the presentation specifications of a key resource, for example by indicating that a key resource is to be left out of the presentation, by supplying different start and/or end times for the key resource, by specifying additional or different parameters for the key resource, etc.

Any number of annotation files can exist for a single timeline file. For example, a number of users might each create an annotation file for the same timeline file. Equally, a single annotation file can describe annotations for more than one timeline file, provided, of course, that the timeline files are sufficiently similar to allow for annotation by the same annotation file.

A timeline file with associated annotation file is generally played or presented by a suitable tool such as a player, which will be described in more detail below, and which interprets the commands of the timeline file playlist and annotation file to present the key resources in the specified manner.

The dependent claims and the subsequent description disclose particularly advantageous embodiments and features of the invention.

To unambiguously tie an annotation for a key resource to that key resource, in a particularly preferred embodiment of the invention a reference verification code is generated for the key resource and is recorded in the annotation file together with the identification of the associated key resource. The reference verification code summarises descriptive information about a key resource file such as file size, file name and path name, date of last modification of that file etc., and is used at a later point in time to verify the key resource for which it has been created. Such a reference verification code might take the form of a string of hexadecimal words or bytes, or any other suitable form. Thereby, at least one reference verification code is generated for a key resource of a timeline file. A number of different reference verification codes can be generated for a key resource, and each of these reference verification codes can be recorded in the annotation for that key resource.

A verification code can be, for example, any one of a simple file hash, a cyclic redundancy check (CRC), a message digest code (MDC), etc. The type of verification code used might depend on the purpose of the verification code, the nature of the key resource being annotated, and the effort required to generate the verification code. The verification code can preferably be filename independent, and can be used to identify or locate a file even if the filename for that file has been modified.

For instance, if a certain key resource is deemed to be relatively unimportant or of less significance, a simple cyclic redundancy check can be generated for the key resource quite quickly, particularly for a relatively small key resource. However, a CRC only offers limited accuracy, since a CRC generated for a modified key resource might have the same value as the original CRC for that key resource.

A more robust type of verification code might be a file hash, or hash table entry, for a key resource. A file hash is a calculated number that uniquely identifies that file, distinguishing it from every other file on the network, and is calculated using appropriate descriptive information for the content file. A file hash is relatively easy to generate, and offers a higher degree of accuracy than a CRC, but does not completely exclude the possibility than a modification to content of the original file might result in an identical file hash. A particular advantage of the file hash is that a small change to an original file is reflected by a pronounced change in the hash of that file.

If copyright, security, or data rights management is an issue, the data file for an important key resource might be protected by a more complex verification code such as a message digest code (MDC), which is effectively a digital signature for the data file. A message digest is a number which is created algorithmically from a file and represents that file uniquely. Any change to the data file, however minor, will result in a different MDC. However, an MDC is cost-intensive to generate, so that it might preferably be used for a key resource that is covered by copyright, such as published content.

As described above, a key resource can be any kind of data file suitable for audio or visual presentation. Particularly in the case of large key resources, such as a full-length movie, it may be the case that an annotation only refers to a part or excerpt of the entire key resource. Therefore, in a preferred embodiment of the invention, the tying of an annotation to a key resource can be effected by tying the annotation to the relevant section or segment of the entire key resource. In other words, the segments of a key resource can effectively be regarded as a key resource and can be referenced from a timeline file or an annotation file. For example, in the case of a timeline file referencing a movie, for which the key resource can easily be several gigabytes in size, it might be preferable to segment the movie, e.g. into chapters, to give excerpts of segments of the movie for which annotations are foreseen. A reference verification code for a segment can also be generated over the segment of the movie. The annotation file for this timeline might therefore only require a reference to the key resource segment—and preferably the reference verification code for that segment—since only changes to that segment of the original movie are of relevance. Furthermore, the step of generating a verification code at a later point in time is made easier by not having to calculate a verification code for the entire original key resource, or movie in this example.

Since the timeline file is external to the annotation file, the situation might arise in which modifications to the timeline file are made without being considered in the annotation file. For example, a user might rename the timeline file but omit to update its reference or pointer in the annotation file. Such a modification might give undesirable results when the annotation and base files are played. Therefore, in a preferred embodiment of the invention, a verification code is also generated for the timeline file and is stored as a reference verification code in the annotation file together with a pointer to the timeline file. Using this reference verification code, the validity of the timeline file itself can be checked at a later point in time. If the player cannot find the timeline file referenced in the annotation file at the specified location on the file system, it might search the file system for a file with the same verification code as that specified in the annotation file.

Preferably, the timeline file and the timeline annotation file are written using an extensible markup language (XML), such as the SMIL markup language, since this language comprises a set of XML modules which are used to describe the temporal, positional, and interactive behaviour of a multimedia presentation.

According to the invention, an appropriate arrangement for annotating a timeline file comprises a key resource identifier for identifying a key resource in the timeline file and an editing means for entering into the annotation file an entry describing an annotation for that key resource or a segment of that key resource, and a link to tie the annotation to that key resource or segment of that key resource. Since such an arrangement displays the usual features of an editor such as file creation, editing and storing capabilities, it will be referred to in the following as an “annotation editor”.

Preferably, such an annotation editor might comprise a verification code generator for generating reference verification codes for key resources of the timeline file and including these in the corresponding annotations for the key resources. Equally, such a verification code generator might be realised separately from the annotation editor.

A user of such an annotation editor might specify a timeline file which he wishes to annotate. The annotation editor might then create an annotation file for this timeline file, and proceed to identify any key resources present in the timeline file. An advantageous embodiment of such an annotation editor might comprise a graphical user interface for presenting the information in a manner easily understood by the user, without necessitating the user to be fluent in the language used to encode the annotation file.

During annotation, the key resources can be identified by the key resource identifier of the annotation editor by analysing the timeline file according to a profile for key resource identification, which might contain a list of keywords, strings or tags generally used to indicate the presence of a key resource in the text of a timeline file. Equally, the annotation editor might be able to parse the timeline file for the presence of markers such as certain strings or tags, so that the key resource identifier can locate the key resources in the timeline file. These markers might have been positioned in the timeline file by the author of the timeline file.

Having located the key resources in the timeline file, the annotation editor can indicate these in an appropriate manner to the user. For example, the annotation editor might indicate—by means of suitable icons, symbols, or text—the key resources present in the timeline file. The user can then simply select one or more of the key resources, for example by clicking on the symbol for that key resource.

The user can avail of the editing means of the annotation editor to compose an entry describing an annotation for a key resource or a segment of a key resource directly into the annotation file if desired, or into a separate file. For example, a modification to the playlist specifications of a key resource in the timeline file, such as changing the start and/or end times for a key resource, can be entered directly into the annotation file. A more complex type of annotation, such as a voice-over to accompany a key resource, might be stored in a separate file, and a reference to this file can be entered into the annotation file at the appropriate position, and with the appropriate play specifications. Evidently, such a separate file containing additional audio-visual material can also be supplied with a reference verification code. To tie the annotation to the corresponding key resource, the user can, using the editing means, enter a link, for example the file name and file path of the key resource, at an appropriate position in the annotation file.

In a preferred embodiment of the invention, the annotation editor might generate a reference verification code for a key resource to tie an annotation for a key resource to that key resource, or the user might himself enter a previously generated reference verification code. This reference verification code might be a simple CRC, a file hash, a MDC, or any other suitable verification code. The type of verification code to be generated for each type of key resource might be pre-defined, specified in a profile for the annotation editor, or specified by the user. A reference verification code can also be created for the timeline file and entered into the annotation file at the appropriate location.

Once the user has finished entering annotation information for the selected timeline file, the annotation file can be encoded to the desired language, for example an extensible markup language, and stored to the file system for later use.

An appropriate method for presenting a timeline file including a number of key resources according to annotations read from a corresponding annotation file which has been generated in the manner described above, comprises identifying a key resource and/or a segment of a key resource in the timeline file, and presenting the key resource or the segment of the key resource according to an annotation tied to that key resource or segment of that key resource. Any resources of the timeline file which are not in any way annotated in the annotation file are played according to the playlist specifications of the timeline file.

In a preferred embodiment of the invention, a verification code is generated for each key resource or segment of a key resource described in an annotation of the annotation file. This verification code is generated in the same way as the reference verification code, so that, if the reference verification code is an MDC for the key resource, the verification code will also be an MDC. The verification code thus generated is compared to the corresponding reference verification code for that key resource. If no discrepancy is detected between verification code and reference verification code, that key resource can be played or presented according to its associated annotation. In the case of a discrepancy or mismatch between verification code and reference verification code for a key resource, the corresponding key resource is played without annotations.

In a preferred embodiment of the invention, the timeline file and the annotation file are merged to give a temporary annotated timeline file, in such a way that the temporary annotated timeline file comprises those key resources of the timeline file that have been annotated according to the annotation file, along with any key resources or other resources of the timeline file that were not annotated in the annotation file. The playlist of the temporary annotated timeline file reflects the annotations specified in the annotation file. As already described above, any annotations for which the key resource cannot be verified are disregarded, so that these annotations do not appear in the temporary annotated timeline file.

Therefore, according to the present invention, an appropriate arrangement for presenting a timeline file according to annotations described in a corresponding annotation file comprises an annotation file reader for reading the annotation file and identifying in it any references to key resources or segments of a key resource in the timeline file, and a timeline file reader for reading the timeline file and identifying key resources in the timeline file. Furthermore, such an arrangement comprises a presenting means for presenting, usually in a synchronized manner, the timeline file according to any annotations of the annotation file that are tied to key resources or segments of key resources in the timeline file.

Such an arrangement or presentation tool might feature the usual file reading capabilities for locating, opening and interpreting the contents of an annotation file and determining the location of the timeline file referenced by the annotation file. Furthermore, the arrangement can comprise suitable interfaces for outputting video and/or audio data. Since presenting the resources of a timeline file generally involves playing them, or forwarding them to appropriate audio or video interfaces, such an arrangement is referred to in the following as a player.

In a preferred embodiment of the invention, the player comprises a verification code generator for generating, after the identification of key resources or segments of a key resource in the timeline file that have been annotated in the annotation file, appropriate verification codes for those key resources. Furthermore, the player comprises a comparator for comparing these verification codes to the corresponding reference verification codes, so that only those annotations for which reference verifications code and verification codes are identical will be taken into account when the timeline file is presented.

Such an arrangement for presenting the timeline file might also merge the annotations and the timeline file to give an annotated timeline, which in turn might be stored to a file system, or played directly by the player.

Therefore, in a preferred embodiment of the invention, an appropriate arrangement for generating an annotated timeline file from a timeline file comprising a number of key resources, and an annotation file comprising annotations to any of the key resources or segments of a key resource comprises an annotation file reader for reading the annotation file and identifying therein references to key resources and/or segments of a key resource in the timeline file and a timeline file reader for reading the timeline file and identifying therein the key resources and/or segments of a key resource. Then, according to whether the reference verification codes and the verification codes of the key resources match or not, the annotation file are merged with the timeline file to give a temporary annotated timeline file in a form suitable for presentation. Such an arrangement for generating an annotated timeline file may be part of a player.

The decisions made by the player might be controlled or influenced by a suitable profile. Such a profile, which might be stored, for example, as a file in the file system, can comprise a set of pre-defined preferences or can be edited or modified by a user to contain a set of user-defined preferences. For example, the player's response to discrepancies between verification code and reference verification code for certain types of key resources might be specified. An example of such a preference might be that the player interrupts the process of analysing the annotation file if it detects a mismatch for an “important” key resource, such as a movie or a soundtrack. Less important key resources, on the other hand, might be specified in the profile to cause the player to issue a suitable comment in the case of a verification code mismatch, without causing the player to interrupt the process. Essentially any kind of player reaction to a verification code mismatch can be configured by the user by means of such a profile, allowing the user to customize the player's performance.

The modules or units of an annotation editor or player, as described above, can be realised in software or hardware or a combination of both software and hardware, as is most appropriate. An annotation editor or presentation tool is preferably realised in the form of a computer program product which can be directly loaded into the memory of a programmable device, e.g. an personal computer, PDA etc., and where the steps of the method are performed by suitable software code portions when the computer program is run on the device.

Other objects and features of the present invention will become apparent from the following detailed descriptions considered in conjunction with the accompanying drawings. It is to be understood, however, that the drawings are designed solely for the purposes of illustration and not as a definition of the limits of the invention.

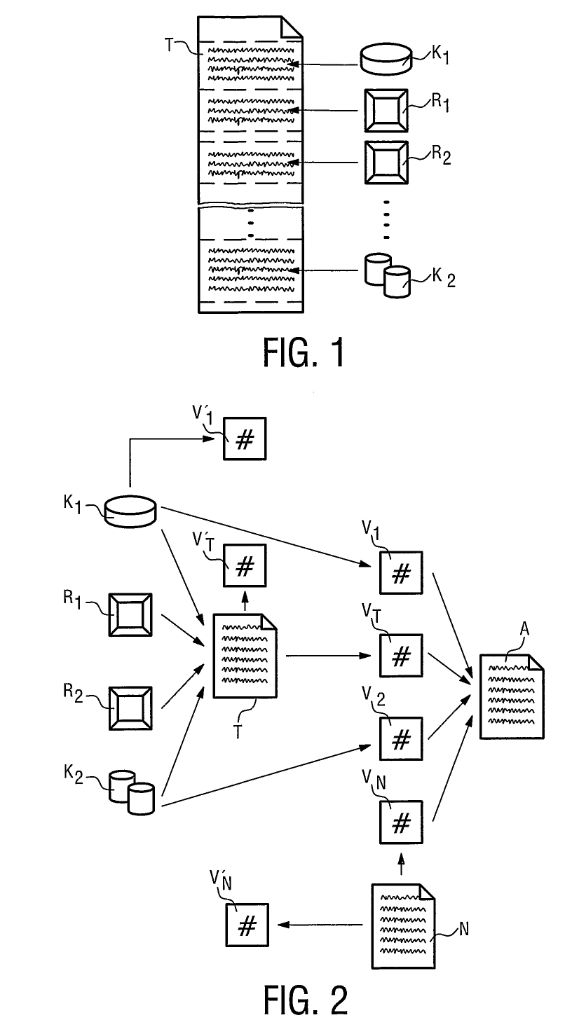

FIG. 1 shows a schematic diagram of a timeline file according to an embodiment of the invention.

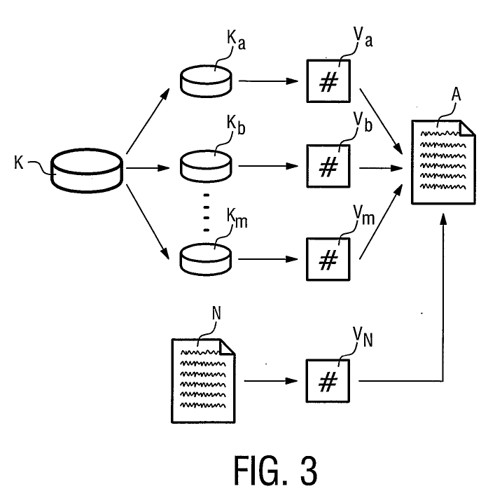

FIG. 2 is a schematic diagram showing key resources, a timeline file, verification codes, and an annotation file according to an embodiment of the invention.

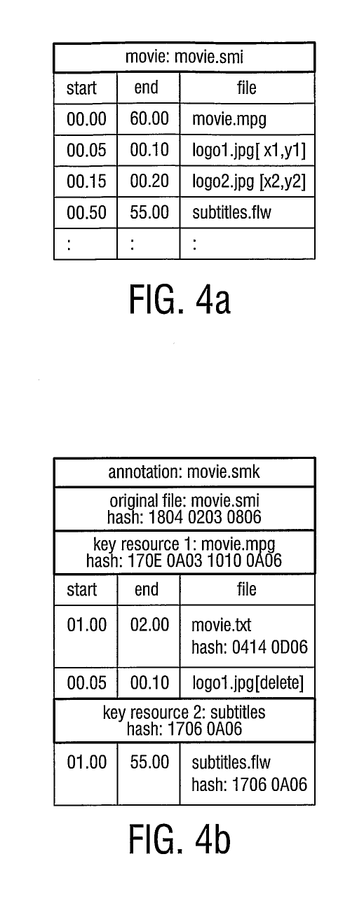

FIG. 3 is a schematic diagram showing a segmented key resource and an associated annotation file.

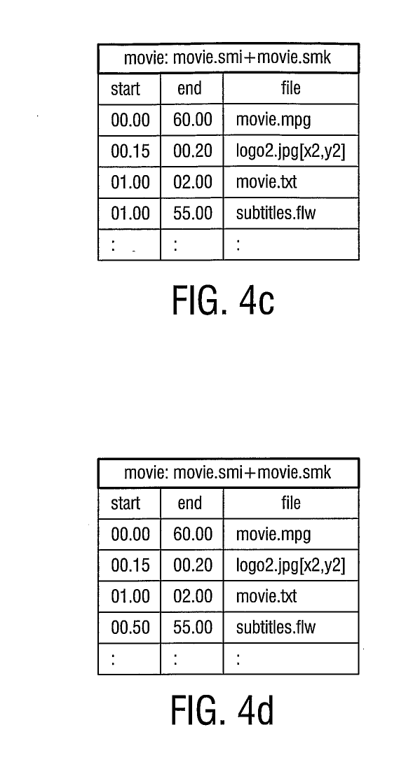

FIGS. 4a-4d show tabular representations of a timeline file, an annotation file, and merged annotated timelines.

In the drawings, like numbers refer to like objects throughout.

FIG. 1 shows a timeline file T, which can be any type of document such as a plain text file or a document produced by an editor. The horizontal black lines shown in the diagram of the timeline file T are intended to indicate the text of a playlist. The playlist of timeline file T references a number of key resources K₁, K₂ and a number of other resources R₁, R₂, which are to be presented when the playlist is played. In this example, the playlist described by the timeline file T references a movie K₁ with subtitles K₂ corresponding to the movie K₁, and, as further resources R₁, R₂, two logos which are to be superimposed for a short duration on the picture. The timeline file T can be figuratively divided into sections, illustrated by the dashed lines across the file, each of which references a resource.

In this example, the timeline file T is encoded in the extensible markup language SMIL, as can be seen in the following code sample:

< --! SMIL document's file name is movie.smi -- >
<smil>
<par>
<video id=“vid” begin=“0s” dur=“60s” src=“movie.mpg” />

<img begin=“vid.begin+0.10s” dur=“0.05s” src=“logo1.jpg” />

<img begin=“vid.begin+0.15s” dur=“0.05s” src=“logo2.jpg” />

<img begin=“vid.begin+0.5s” dur=“54.5s” src=“subtitles.flw” />

...
</par>
</smil>

As this code example illustrates, a number of resources (of “video” and “img”, or image, type) are referenced in a SMIL file, whose filename in the file system is “movie.smi”. The location in the file system of a key resource K₁, K₂ or other resource R₁, R₂ is given by the “src” identifier, which yields the filename and path of the resource K₁, K₂, R₁, R₂. In this example, all the resources are evidently to be found in the same directory as the SMIL file itself.

All of the resources run in parallel, as indicated by the opening <par> and closing </par> tags. A start time of 0 s is given for the “movie.mpg” key resource K₁, and defined as “vid.begin”, which will be the reference time for the following resources K₂, R₁, R₂. The movie K₁ is to run for 60 s, as specified by the “dur”, or duration, identifier. Thus, the first logo R₁ appears 0.10 s after the movie K₁ commences, and disappears after a duration of 0.05 s. The second logo R₂ is to appear 0.15 s after the movie K₁ commences, and also remain visible for 0.05 s. The subtitles K₂ are to commence 0.5 s after the movie K₁ starts, and are to run for 54.5 s.

Annotations to the timeline file T are encoded in a separate annotation file A. There may be any number of annotation files for a single timeline file T. An annotation to a timeline file T can be directly encoded in the annotation file A, or encoded in an additional file for which a reference is encoded in the annotation file A. Such an annotation can be an additional resource reference, an indication that a resource of the timeline file is to be disregarded when playing the timeline file T, a modification of the play times specified in the timeline file T for a key resource, etc.

According to a preferred example of the invention, any key resources referred K₁, K₂ to in an annotation file A can be verified before the playlist is played. FIG. 2 shows a block diagram of a timeline file T, its resources K₁, K₂, R₁, R₂, and an annotation file A. The annotation file A is understood to contain references to the timeline file T, an annotation N to the movie K₁, and subtitles K₂ to accompany the movie. For the timeline file T, the external annotation N, and each referenced key resource K₁, K₂ which requires verification before playing, the annotation file A also records a reference verification code V₁ for the movie, a reference verification code V₂ for the movie subtitles, a reference verification code V_{T} for the timeline file itself, and a reference verification code V_{N} for the external annotation.

The text of an annotation file A for the timeline file T according to the above example is shown in the following code sample. The annotation file's filename in the file system is “movie.smk”, as indicated in the comment tag in the first line of code.

< --! The annotation file of movie.smi. The file name is movie.smk -- >
<smirk>

<annotation id=“1804 0203 0806” ref=“movie.smi”>

<par>
<key resource id=“170E 0A03 1010 0A06” ref=“movie.mpg” />
<text id=“0414 0D06” begin=“01.00s” dur=“01.00s”
src=“movie.txt”/>
<img begin=“00.05s” dur=“0.00s” src=“logo1.jpg” />
</par>
<par>
<key resource id=“1706 0A06” ref=“subtitles.flw” />
<img id=“1706 0A06” begin=“01.00s” dur=“54.00s”
src=“subtitles.flw” />
</par>

</annotation>

</smirk>

An annotation block is described within the opening <annotation> and closing </annotation> tags, for the timeline file given by the reference “movie.smi”. Also specified, by the reference “id”, is the reference verification code V_{T}—a file hash—for the timeline file T. Thereafter, between the first pair of <par>and </par> tags, an annotation for the key resource K₁ “movie.mpg” is described. This key resource reference is accompanied by its reference verification code V₁ in which the contents of the file N, “movie.txt”, are to accompany the movie K₁ for the duration of Is, starting at 1 s after the movie commences. The first logo R₁, “logo1.jpg”, is effectively removed from the timeline T by changing its duration to 0 s. Since nothing is entered for the second logo R₂, “logo2.jpg”, its appearance and behaviour in the timeline T will not be affected.

In the following <par> block, the duration of play for the subtitles K₂ is altered, so that these start Is after the movie commences, and play for a total of 54 s. A file hash is generated as reference verification code V₂, and recorded in the annotation file A together with the reference to the subtitles.

In the event that a verification code V′_{T}, V′₁, V′₂, V′_{N} differs from the corresponding reference verification code V_{T}, V₁, V₂, V_{N}, the player must make an appropriate decision.

If the verification code V′_{T} for the timeline file T differs from its reference verification code V_{T}, the player conclude that modifications have been made to the timeline file T, and might interrupt the playing process. On the other hand, if the player cannot find the timeline file at the specified location, it might search the file system for a timeline file with the verification code specified in the annotation file.

If the timeline file T can be successfully verified, it remains to check the validity of the key resources K₁, K₂ referenced in the annotation file A. In this example, the verification codes V′₁, V′₂, V′_{N} of the movie K₁ and a supplementary file N are checked against their corresponding reference verification codes V₁, V₂, V_{N}. If the verification code V′₁ for the movie K₁ should differ from its reference verification code V₁, this would indicate that the current version of the movie K₁ is different from the version referred to in the timeline file T, or that it might have been edited in some way. Since the changes to the movie K₁ might mean that the video sequence can no longer be meaningfully combined with the contents of the accompanying external annotation file N, the player disregards the annotations given by the external annotation file N. In this example, where the movie K₁ is clearly the carrier of the playlist, the player might conclude that the entire playlist be terminated without playing, or might simply play the playlist in its original form, disregarding the entire annotation file A. In the case of a discrepancy between the reference verification code of another key resource and its corresponding verification code, the player might decide to simply omit or disregard this annotation, while continuing to play the other, successfully verified key resources according to the annotations in the annotation file A. These decisions made by the player can be influenced or controlled by means of a profile. Any other resources of the timeline, which are not annotated in any way in the annotation file, can be played as originally specified in the timeline file

If a key resource is a full-length movie, a soundtrack etc., annotations to this key resource may only refer to a section of the key resource. Such a section or segment might be simply an excerpt from a movie, a soundtrack, or other audio-visual content. A reference verification code can be calculated for any such key resource segment. FIG. 3 shows a movie K which is divided into segments or sections, each of which is thereafter a key resource segment Kₐ, K_{b}, . . . , Kₘ. The movie K is referenced from a playlist in a timeline file (not shown in the diagram), and annotations for one or more of the film excerpts or segments are described in an annotation file A. Reference verification codes Vₐ, V_{b}, . . . , Vₘ are generated for each of the annotated key resource segments Kₐ, K_{b}, . . . , Kₘ and referred to in an annotation file A. Annotation information for the key resource segments Kₐ, K_{b}, . . . , Kₘ, for example an accompanying voice-over for a segment etc., are described in the annotation file A or separately. Such a supplementary file N is shown in the diagram. A reference verification code is generated for this file N and referred to in the annotation file A. For the sake of clarity, only one file N containing annotation information has been shown in this diagram, but it is evident that any number of supplementary files can be referenced by the annotation file A. Equally, any number of annotations can be directly encoded in the annotation file A.

FIGS. 4a-4d show tabular representations of programme code for a timeline file, an annotation file, and merged annotated timelines. The timeline file, the annotation file and the merged timeline files might be encoded using a XML languages or other suitable language. For the sake of clarity, only the relevant elements of a timeline, an annotation etc. are shown in the tabular representations.

FIG. 4a shows a tabular representation of a timeline file. In this example, the timeline file comprises a playlist defining the sequence of playing of a short movie in MPEG format (“movie.mpg”), a first image in JPEG format (“logo1.jpg”), a second image in JPEG format (“logo2.jpg”), and a subtitle flow to accompany the movie (“subtitles.flw”). Any number of other elements might follow in the playlist.

The start and end times for each element are indicated in the first and second columns of the table, and are given in seconds, so that the movie itself starts at time zero or “00.00” and plays for sixty seconds, given by “60.00”. The first logo is superimposed on the movie picture, appearing a twentieth of a second after the movie has commenced playing, and remaining visible for a twentieth of a second. Its position on the screen is given by the accompanying [x1,y1] coordinates. A second logo appears another twentieth of a second later, at a position indicated by [x2, y2], and also remains visible for a twentieth of a second before disappearing. The subtitles start to run at half a second after the movie commences, and continue running until five seconds before the movie is set to conclude. As this example demonstrates, elements of a playlist can play concurrently or sequentially.

Annotations to this timeline file are shown in FIG. 4b, which is a tabular representation of a SMIRK file, called “movie.smk”. Here, the key resources of the timeline file are identified and annotated.

The name of the timeline file being annotated is referenced as “movie.smi”. The verification code of the timeline file, in this case a file hash, is also recorded at this point. A first key resource is identified, namely the movie itself—“movie.mpg”—and accompanied by a file hash for the MPEG file. The actual annotation for the movie then follows. In this example, an accompanying file “movie.txt”—is referenced along with the file hash for the text file. The contents of the text file, which might be any kind of annotation such as a voice-over, an additional sound-track with spoken comments, a set of images for overlaying on the original movie picture etc., run for the specified duration, in this case for one second, starting one second after commencement of the movie. The first image referenced in the original timeline file, “logo1.jpg”, is removed from the playlist by an appropriate command in the annotation file, indicated here by “[delete]”, so that this image is not superimposed on the movie while this is being played.

A second key resource, the subtitles, is identified, along with a file hash for the “subtitles.flw” file. The annotation entry for this key resource indicates that the start time for the subtitles is changed to one second after commencement of the movie, instead of half a second, as specified in the original timeline file.

When a user wishes to play the timeline file with the accompanying annotations, he might use a suitable presentation tool or player which can interpret the formats of the timeline file and the annotation file, and can access the elements specified in these files. The player first examines the annotation file for an entry pointing to a timeline file. If this entry is accompanied by a reference verification code, the player generates a verification code and compares this to the reference verification code. If a mismatch is detected, processing of the annotation file is interrupted.

If the verification codes for the timeline file check out, the player can continue to look for key resources in the annotation file. Having identified the first key resource in this example—“movie.mpg”—and its reference file hash, the player generates a new file hash and checks this against the reference file hash. The procedure is repeated for the second key resource in the example—“subtitles.flw”. If the verification codes for all the key resources check out, the player continues by merging the timeline file and the annotation file to give an annotated playlist, as indicated in FIG. 4c.

The start and end times for the elements in the annotated playlist reflect the original start and end times specified in the timeline file with any modifications that may have been specified in the annotation file. Elements of the timeline file that have been deleted in the annotation file do not appear in the annotated playlist. Elements contributed by the annotation file, such as the “movie.txt” contribution, appear at the appropriate location in the playlist.

In the case of a discrepancy or mismatch between a verification code and its corresponding reference verification code, the player must decide if the process should continue. In this example, it might be that the subtitles file was edited, but the reference to its file hash was not updated in the annotation file. Here, the player detects a mismatch between the newly generated hash table entry for the subtitles.flw file, and the reference hash table entry specified in the annotation file. As a result, the player disregards the annotations for the subtitles entirely, and puts together the annotated playlist as shown in FIG. 4d. The subtitles will be played as specified in the original timeline.

The advantages of the method described above are that, if the timeline file is changed, whilst the key resources or the annotation file are not changed, the timeline file will still be valid. Also, even if modifications are made to one or more key resources, annotations for the remaining key resources retain their validity. The file names of the timeline file and key resources can be changed without influencing the validity of the timeline file or the corresponding annotation.

Although the present invention has been disclosed in the form of preferred embodiments and variations thereon, it will be understood that numerous additional modifications and variations could be made thereto without departing from the scope of the invention. For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A method of annotating a timeline file (T), which method comprises identifying distinct key resources (K₁, K₂, K) in the timeline file (T), and describing a number of annotations for one or more key resources (K₁, K₂, K) in an annotation file (A) such that an annotation for a key resource (K₁, K₂, K) is tied to the key resource (K₁, K₂, K) corresponding to that annotation.

2. A method as claimed in claim 1, wherein an annotation for a key resource (K) is tied to a segment (Kₐ, K_{b}, . . . , Kₘ) of the key resource (K) corresponding to that annotation.

3. A method as claimed in claim 1, wherein at least one reference verification code (V₁, V₂, Vₐ, V_{b}, . . . , Vₘ) is generated for a key resource (K₁, K₂) or a segment (Kₐ, K_{b}, . . . , Kₘ) of a key resource (K) of a timeline file (T), and an annotation in an annotation file (A) corresponding to that key resource (K₁, K₂) or segment (Kₐ, K_{b}, . . . , Kₘ) of the key resource (K) is linked to the reference verification code (V₁, V₂, Vₐ, V_{b}, . . . , Vₘ) for that key resource (K₁, K₂,) or segment (Kₐ, K_{b}, . . . , Kₘ) of that key resource (K).

4. A method as claimed in claim 1, wherein a reference verification code (V_{T}) is generated for the timeline file (T).

5. A method as claimed in 1, wherein a key resource (K₁, K₂, K) in a timeline file (T) is identified automatically according to a profile for key resource identification and/or according to markers in the timeline file (T).

6. A method as claimed in claim 1, wherein the verification code (V_{T}, V₁, V₂, Vₐ, V_{b}, . . . , Vₘ) for a timeline file (T) or a key resource (K₁, K₂) or a segment (Kₐ, K_{b}, . . . , Kₘ) of a key resource (K) comprises a hash table entry and/or a message digest code and/or a cyclic redundancy check.

7. A method for presenting a timeline file (T) comprising a number of key resources (K₁, K₂, K) according to annotations read from a corresponding annotation file (A),
generated according to claim 1, which method comprises
identifying a key resource (K₁, K₂, K) and/or a segment (Kₐ, K_{b}, . . . , Kₘ) of a key resource (K) in the timeline file (T),
and presenting the key resource (K₁, K₂, K₃, . . . , Kₘ) or the segment (Kₐ, K_{b}, . . . , Kₘ) of the key resource (K) according to an annotation tied to that key resource (K₁, K₂, K) or that segment (K₁, K_{b}, . . . , Kₘ) of that key resource (K).

8. A method according to claim 6, which method comprises the following steps:
generating a verification code (V₁, V₂, Vₐ, V_{b}, . . . , Vₘ) for the key resource (K₁, K₂) or segment (Kₐ, K_{b}, . . . , Kₘ) of the key resource (K) described in an annotation of the annotation file (A);
comparing the verification code (V′₁, V′₂,) with the corresponding reference verification code (V₁, V₂, Vₐ, V_{b}, . . . , Vₘ);
and presenting the key resource (K₁, K₂) or the segment (Kₐ, K_{b}, . . . , Kₘ) of the key resource (K) according to its associated annotation if no differences are detected between its verification code (V′₁, V′₂) and the corresponding reference verification code (V₁, V₂, Vₐ, V_{b}, . . . , Vₘ), or presenting the key resource (K₁, K₂) or the segment (Kₐ, K_{b}, . . . , Kₘ) of the key resource (K) without its associated annotation in the case of a discrepancy between its verification code (V′₁, V′₂,) and the corresponding reference verification code (V₁, V₂, Vₐ, V_{b}, . . . , Vₘ).

9. A method as claimed in claim 8, wherein the timeline file (T) is merged with those annotations of the annotation file (A) for which the verification codes (V′₁, V′₂,) match their corresponding reference verification codes (V₁, V₂, Vₐ, V_{b}, . . . , Vₘ), to give a temporary annotated timeline file suitable for presentation.

10. An arrangement for annotating a timeline file (T), comprising
a key resource identifier for identifying a key resource (K, K₁, K₂) in the timeline file (T);
and an editing means for entering into the annotation file (A) an entry describing an annotation for that key resource (K₁, K₂) or a segment (Kₐ, K_{b}, . . . , Kₘ) of that key resource (K) and a link to tie the annotation to that key resource (K, K₁, K₂) or segment (Kₐ, K_{b}, . . . , Kₘ) of that key resource (K).

11. An arrangement for presenting a timeline file (T) comprising a number of key resources (K, K₁, K₂) according to annotations described in a corresponding annotation file (A) generated according to claim 1, which arrangement comprises
an annotation file reader for reading the annotation file (A) and identifying therein references to key resources (K, K₁, K₂) and/or segments (Kₐ, K_{b}, . . . , Kₘ) of a key resource (K) in the timeline file (T);
a timeline file reader for reading the timeline file (T) and identifying therein key resources (K, K₁, K₂,) and/or segments (Kₐ, K_{b}, . . . , Kₘ) of a key resource (K);
and a presenting means for presenting the timeline file (T) according to any annotations of the annotation file (A) tied to corresponding key resources (K, K₁, K₂) or segments (Kₐ, K_{b}, . . . , Kₘ) of a key resource (K).

12. An arrangement for generating an annotated timeline file from a timeline file (T) comprising a number of key resources (K, K₁, K₂), and an annotation file (A) comprising annotations to any of the key resources (K₁, K₂) or segments (Kₐ, K_{b}, . . . , Kₘ) of a key resource (K) and generated according to claim 1, wherein the arrangement comprises
an annotation file reader for reading the annotation file (A) and identifying therein references to key resources (K, K₁, K₂) and/or segments (Kₐ, K_{b}, . . . , Kₘ) of a key resource (K) in the timeline file (T);
a timeline file reader for reading the timeline file (T) and identifying therein the key resources (K, K₁, K₂) and/or segments (Kₐ, K_{b}, . . . , Kₘ) of a key resource (K);
a merging unit for merging, in an annotated timeline file, the key resources (K, K₁, K₂) of the timeline file (T) with any annotations of the annotation file (A) tied to the key resources (K, K₁, K₂) or segments (Kₐ, K_{b}, . . . , Kₘ) of a key resource (K).

13. A computer program product directly loadable into the memory of a programmable device, comprising software code portions for performing the steps of a method according to claim 1 when said product is run on the device.
